(19) United States
(12) Patent Application Publication
(10) Pub. No.: US 2008/0155355 A1
(43) Pub. Date: Jun. 26, 2008

(54) System diagnostics using XML serialization and hash values

(75) Inventor: Srdjan Boskovic, Walldorf (DE)

Correspondence Address: SCHWEGMAN, LUNDBERG & WOESSNER/SAP, P.O. BOX 2938, MINNEAPOLIS, MN, 55402, US

(73) Assignee: SAP AG

(21) Appl. No.: 11/644,278

(22) Filed: Dec. 21, 2006

(51) Int. Cl. G06F 11/00

(52) U.S. Cl. 714/45; 714/E11.001

(57) ABSTRACT

Information on program flow and/or data associated with program execution is captured in a processor-based system. This information may be in XML format. Captured data that is not in XML format is serialized into XML. The captured data may be used to diagnose and analyze the system.

### TECHNICAL FIELD

Various examples relate to the field of processor-based system analysis and diagnostics, and in an example, but not by way of limitation, the analysis and diagnosis of processor-based systems using a call trace with data functionality.

### BACKGROUND

System analysis of computer and other processor-based systems is an involved and painstaking process. Such systems analyses may include system testing, unit and/or module testing, and performance analysis, just to name a few.

Whatever the analysis, test data is normally required for that analysis. The creation and maintenance of such test data and the expected output generated by that test data is not a trivial task. This is particularly true when a system comprises a multitude of modules or units, and each module requires a different format for its input data and produces its output data in a different format. This is further complicated when one is dealing with multiple systems, such as a production or customer system and a test or reference system. Such test data is normally painstakingly manually prepared, and as such, is susceptible to errors.

A call trace functionality is a common way to analyze a system. An activated call trace generates a tree-list of executed modules. Another functionality, sometimes referred to as call trace with data, generates the runtime data associated with the modules listed in the tree-list of executed modules. The call trace with data functionality may work quite well in simple systems with a single type of data. However, when dealing with systems with a multitude of modules that deal with a multitude of data types, the variety of data types can become quite cumbersome and not conducive to data analysis. The art is therefore in need of an alternative method of analyzing and/or testing processor-based systems, and in particular, an alternative method of analyzing such systems when using a call trace or call trace with data functionality.

### BRIEF DESCRIPTION OF THE DRAWINGS

FIG. 1 illustrates a flowchart of an example embodiment of a system diagnosis process using XML serialization and hash values.

FIG. 2 illustrates a flowchart of another example embodiment of a system diagnosis process using XML serialization and hash values.

FIG. 3 illustrates a block diagram of an example embodiment of a system to implement a system diagnosis process using XML serialization and hash values.

FIG. 4 illustrates an example embodiment of a processor-based system upon which and in connection with which one or more examples of the present disclosure may operate.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

In an embodiment, a call trace with data functionality is modified such that the input and output data of the called modules are serialized into XML and thus marshaled to a common data type—in this instance an XML string. Output of the call trace functionality that produces a tree-list of executed modules may also be serialized into an XML format. Thus, identification of differences between the call traces and the call traces with data between two systems is a matter of comparing the XML documents generated by the serialization. As is known in the art, there are many standard solutions directed to the comparison of two or more XML documents.

If the amount of data is extensive, another embodiment generates hash values using the call trace with data. In another embodiment, the length of the XML string can be incorporated into a call trace with data, which provides information on data flow which is very valuable for performance analysis. In yet another embodiment, a checksum value may be calculated for a call trace with data. If the two checksums are equal, the comparison of the call traces need not be done.

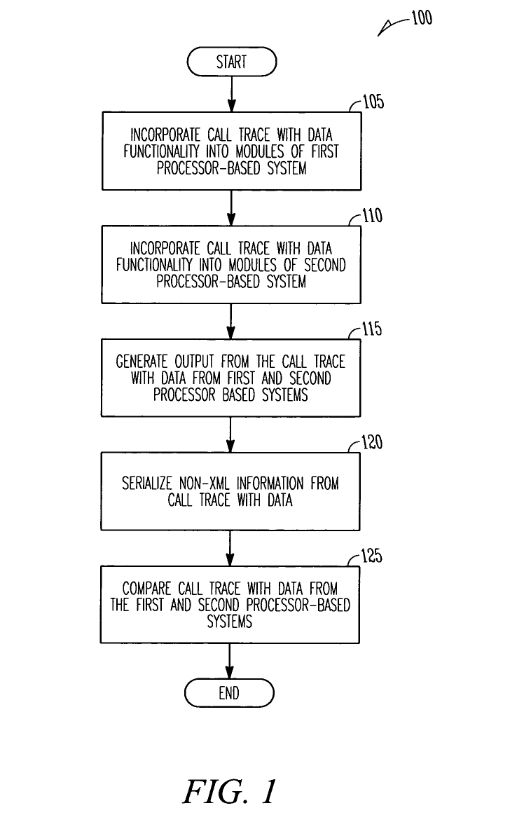

FIG. 1 illustrates an example process 100 of a diagnostic process using XML generated by a system and/or serialized data. At operation 105, a call trace with data functionality is incorporated into one or more modules of a first processor-based system, and at operation 110, the call trace with data functionality is incorporated into one or more modules of a second processor-based system. These call traces with data can generate both a program flow output and a data output. At operation 115, output from the call trace with data is generated on the first processor-based system and the second processor-based system. If the output from the call trace with data is in a non-XML format, then at 120, this non-XML information is serialized into an XML format. At operation 125, the call trace with data of the first processor-based system is compared with the call trace with data of the second processor-based system.

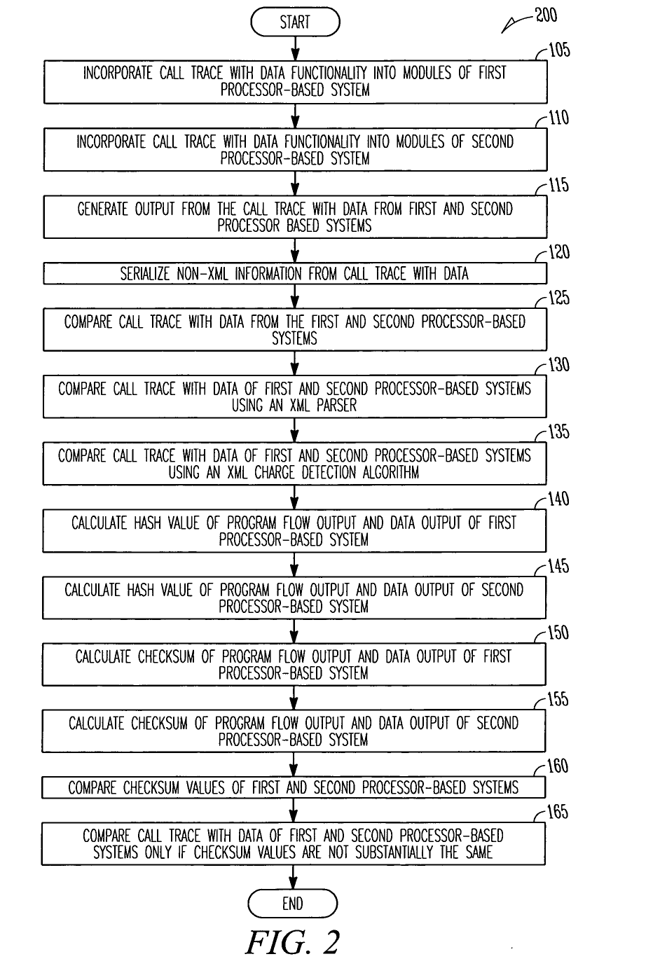

FIG. 2 illustrates another embodiment of a process 200 of a diagnostic process using XML generated by a system and/or serialized data. The process 200 of FIG. 2 includes the operations 105, 110, 115, 120, and 125 as disclosed in FIG. 1, and several additional operations. For example, at operation 130, the comparison of the call trace with data of the first processor-based system with the call trace with data of the second processor-based system is executed using an XML parser. In contrast, at operation 135, the comparison of the call trace with data of the first processor-based system with the call trace with data of the second processor-based system is executed using an XML change detection algorithm.

FIG. 2 further illustrates that at operation 140, a hash value is calculated for the program flow output and the data output generated by the call trace with data in the first processor-based system, and at operation 145, a hash value is calculated for the program flow output and the data output generated by the call trace with data in the second processor-based system. In operations 140 and 145, the hash values for the first processor-based system and the second processor-based system are calculated before the comparison of the serialized program flow output and data output of the first processor-based system with the serialized program flow output and data output of the second processor-based system, and the comparison of the serialized program flow output and data output of the first processor-based system with the serialized program flow output and data output of the second processor-based system is performed only if the hash value of the first processor-based system is not substantially the same as the hash value of the second processor-based system.

At operation 150 and 155, the serializing of the program flow output and the data output generated by the call trace with data in the first processor-based system and the serializing of the program flow output and the data output generated by the call trace with data in second processor-based system includes a calculation of a checksum, and at operation 160, the checksum value from the first processor-based system and the checksum value from the second processor-based system are compared. At operation 165, the comparison of the call trace with data of the first processor-based system with the call trace with data of the second processor-based system is performed only if the checksum value of the first processor-based system is not substantially the same as the checksum value of the second processor-based system.

In both process 100 of FIG. 1 and process 200 of FIG. 2, the first processor-based system and the second processor-based system may be the same system. In another embodiment, the two systems may be substantially similar systems, such as a production or customer system and a related test or reference system. In yet another embodiment, the first processor-based system and the second processor-based system may be the exact same system. The processes of FIG. 1 and FIG. 2 may be embedded in coded instructions on a machine or computer readable medium.

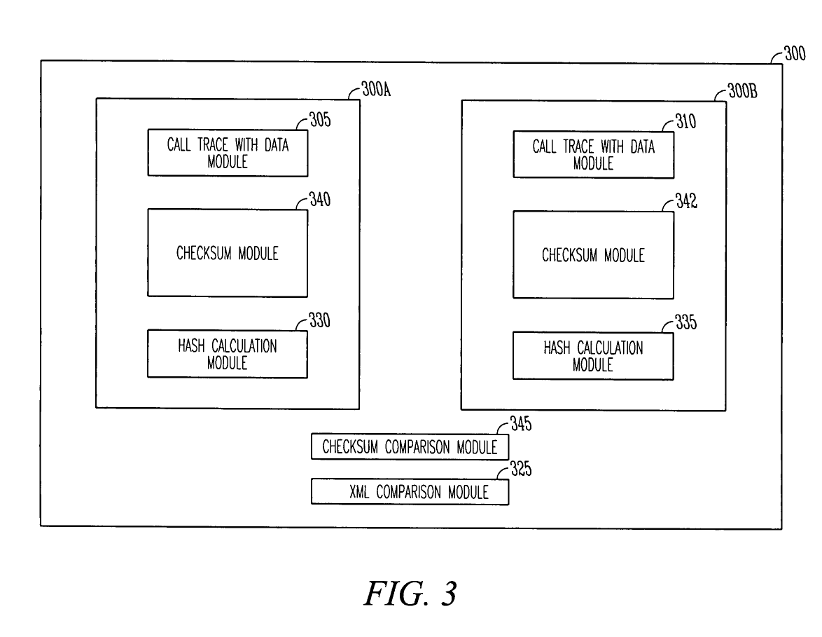

FIG. 3 illustrates a block diagram of an example embodiment of a system 300 which may be used to implement a diagnostic process using XML data and serialized data. The system 300 includes a sub-system 300A on a first processor-based system and a sub-system 300B on a second processor-based system. The system 300 includes a module 305 to incorporate a call trace with data functionality into one or more modules of a first processor-based system, a module 310 to incorporate the call trace with data functionality into one or more modules of a second processor-based system. A module 325 compares the call trace with data of the first processor-based system with the call trace with data of the second processor-based system.

In a particular embodiment of the system 300, the module 325 to compare the call trace with data of the first processor-based system with the call trace with data of the second processor-based system uses an XML parser. In a different embodiment, the module 325 to compare the call trace with data of the first processor-based system with the call trace with data of the second processor-based system uses an XML change detection algorithm.

FIG. 3 further illustrates that the system 300 may include a module 330 to calculate a hash value for the call trace with data in the first processor-based system, and a module 335 to calculate a hash value for the call trace with data in the second processor-based system. In these modules 330 and 335, the hash values for the first processor-based system and the second processor-based system are calculated before the comparison of the call trace with data of the first processor-based system with the call trace with data of the second processor-based system. Additionally, in another embodiment, the module 325 to compare the call trace with data of the first processor-based system with the call trace with data of the second processor-based system executes only if the hash value of the first processor-based system is not substantially the same as the hash value of the second processor-based system.

In another particular embodiment, a module 340 and a module 342 calculate a checksum. The system 300 may further include a module 345 to compare the checksum value from the first processor-based system and the checksum value from the second processor-based system. In various embodiments of the system 300 of FIG. 3, the module 325 to compare the call trace with data of the first processor-based system with the call trace with data of the second processor-based system is executed only if the checksum value of the first processor-based system is not substantially the same as the checksum value of the second processor-based system.

While the first processor-based system 300A and the second processor-based system 300B of FIG. 3 have been drawn as two separate entities, it should be noted that the first processor-based system and the second processor-based system may be the same system. In another embodiment, the two systems may be substantially similar systems, such as a production or customer system and a related test or reference system. In yet another embodiment, the first processor-based system and the second processor-based system may be the exact same system. An example in which the first processor-based system and the second processor-based system are the same system may involve the use of two call traces with data for two processes executed in the same system. These two processes may be parallel processes running on different processors. In such a case, the same input data could be used for the parallel processes, and the differences in the parallel processes could be identified.

In an embodiment, the call trace with data may be implemented as a dedicated module in a system. In another embodiment, the call trace with data functionality may be implemented in connection with a debugger and/or a programmable data recorder. As noted above, the call trace with data functionality generates XML content with information on the program flow and/or data associated with the program. If there is non-XML data present in the system, that data can be serialized into XML. Similarly, a programmable data recorder can include code within a module that extracts data (either XML format or non-XML format) associated with the execution of the module. In contrast to the data capture functionalities a call trace with data, a programmable data recorder, and/or a debugger, a source code generator generates source code that resembles the data associated with the execution of the program. This source code can then be moved from the first processor-based system to the second processor base system where it can be inserted into a module and tested.

Additionally, the call trace with data can be analyzed in an off-line debugging environment. In traditional, on-line debugging, the debugee steps through the program execution and investigates the program flow and data. It is done manually and on-line, with temporary breaks of the program execution. By comparison, off-line debugging may be defined as a methodology of extraction of information on program flow and/or processed data from a running system, with or without the interrupting the program execution, and later analysis of captured information, by human or machine. Information can be extracted using one or more of a call trace, a call-trace with data, a programmable data recorder or even a classical debugger with XML exports. Such information can be captured as one or more XML documents and investigated later, off-line, by a human or a machine.

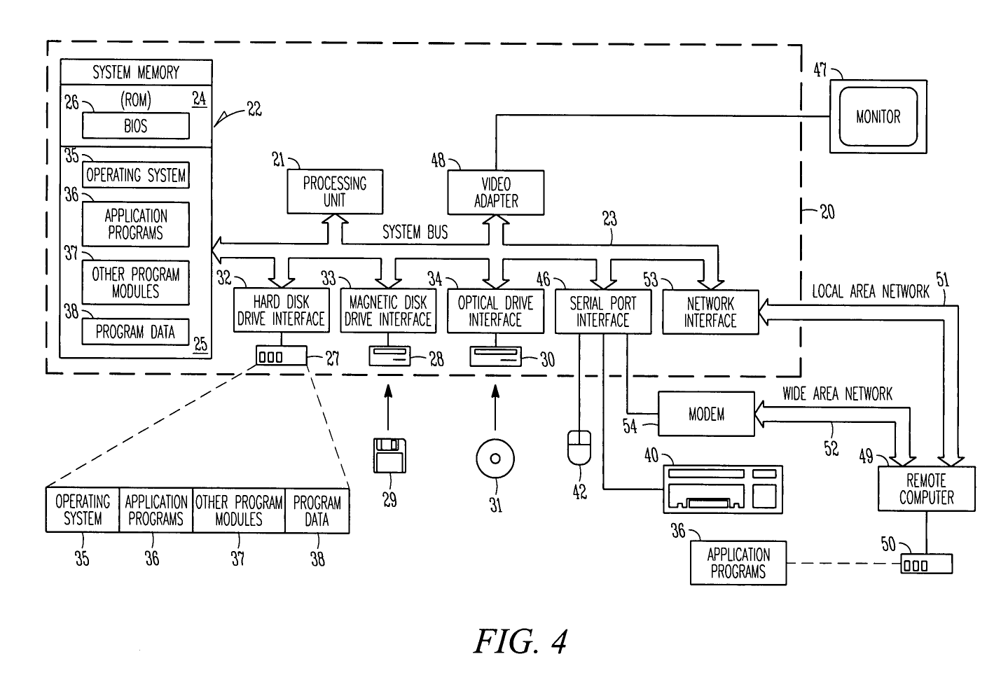

FIG. 4 is an overview diagram of a hardware and operating environment in conjunction with which embodiments of the disclosure may be practiced. The description of FIG. 4 is intended to provide a brief, general description of suitable computer hardware and a suitable computing environment in conjunction with which the disclosure may be implemented. In some embodiments, the examples of the disclosure are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the examples of the disclosure may be practiced with other computer system configurations, including handheld devices, multiprocessor systems, microprocessor-based or programmable consumer electronics, network PCS, minicomputers, mainframe computers, and the like. The examples of the disclosure may also be practiced in distributed computer environments where tasks are performed by I/0 remote processing devices that are linked through a communications network. In a distributed computing environment, program modules may be located in both local and remote memory storage devices.

In the embodiment shown in FIG. 4, a hardware and operating environment is provided that is applicable to any of the servers and/or remote clients shown in the other Figures.

As shown in FIG. 4, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the examples in the disclosure are not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 5 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

In the foregoing detailed description, various features are grouped together in one or more examples or examples for the purpose of streamlining the disclosure. This method of disclosure is not to be interpreted as reflecting an intention that the claimed examples of the invention require more features than are expressly recited in each claim. Rather, as the following claims reflect, inventive subject matter lies in less than all features of a single disclosed example. Thus the following claims are hereby incorporated into the detailed description of examples of the invention, with each claim standing on its own as a separate example. It is understood that the above description is intended to be illustrative, and not restrictive. It is intended to cover all alternatives, modifications and equivalents as may be included within the scope of the invention as defined in the appended claims. Many other examples will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

1. A method comprising:
incorporating a call trace with data into one or more modules of a first processor-based system;
incorporating the call trace with data into one or more modules of a second processor-based system;
generating output from the call trace with data on the first processor-based system; and
generating output from the call trace with data on the second processor-based system;
wherein the output of the call trace with data includes XML information on one or more of program flow and data associated with execution of the first and second processor-based systems, and further comparing the output of the call trace with data of the first processor-based system with the output of the call trace with data of the second processor-based system when the output of the call trace with data comprises an XML format; and further
wherein the output of the call trace with data includes non-XML information on one or more of program flow and data associated with execution of the first and second processor-based systems, and further comprising serializing the non-XML information into an XML format and comparing the serialized data.

2. The method of claim 1, wherein the comparing the call trace with data of the first processor-based system with the call trace with data of the second processor-based system uses an XML parser.

3. The method of claim 1, wherein the call trace with data of the first processor-based system with the call trace with data of the second processor-based system uses an XML change detection algorithm.

4. The method of claim 1, further comprising:
calculating a hash value for the call trace with data of the first processor-based system; and
calculating a hash value for the call trace with data of the second processor-based system;
wherein the hash values for the first processor-based system and the second processor-based system are calculated before the comparison of the call trace with data of the first processor-based system with the call trace with data of the second processor-based system; and further
wherein the comparison of the call trace with data of the first processor-based system with the call trace with data of the second processor-based system is performed only if the hash value of the first processor-based system is not substantially the same as the hash value of the second processor-based system.

5. The method of claim 1, wherein the serializing of the non-XML information in the first processor-based system and the serializing the non-XML information in second processor-based system includes a calculation of a checksum; and further comprising comparing the checksum value from the first processor-based system and the checksum value from the second processor-based system.

6. The method of claim 5, wherein the comparison of the call trace with data of the first processor-based system with the call trace with data of the second processor-based system is performed only if the checksum value of the first processor-based system is not substantially the same as the checksum value of the second processor-based system.

7. The method of claim 1, wherein the first processor-based system is substantially similar to the second processor-based system.

8. A system comprising:
a module to incorporate a call trace with data into one or more modules of a first processor-based system;
a module to incorporate the call trace with data into one or more modules of a second processor-based system;
a module to generate output from the call trace with data on the first processor-based system; and
a module to generate output from the call trace with data on the second processor-based system;
wherein the output of the call trace with data includes XML information on one or more of program flow and data associated with execution of the first and second processor-based systems, and further comprising a module to compare the output of the call trace with data of the first processor-based system with the output of the call trace with data of the second processor-based system when the output of the call trace with data comprises an XML format; and further
wherein the output of the call trace with data includes non-XML information on one or more of program flow and data associated with execution of the first and second processor-based systems, and further comprising a module to serialize the non-XML information into an XML format and a module to compare the serialized data.

9. The system of claim 8, wherein the module to compare the call trace with data of the first processor-based system with the call trace with data of the second processor-based system uses an XML parser.

10. The system of claim 8, wherein the module to compare the call trace with data of the first processor-based system with the call trace with data of the second processor-based system uses an XML change detection algorithm.

11. The system of claim 8, further comprising:
a module to calculate a hash value for the call trace with data of the first processor-based system; and
a module to calculate a hash value for the call trace with data of the second processor-based system;
wherein the hash values for the first processor-based system and the second processor-based system are calculated before the comparison of the call trace with data of the first processor-based system with the call trace with data of the second processor-based system; and further
wherein the module to compare the call trace with data of the first processor-based system with the call trace with data of the second processor-based system executes only if the hash value of the first processor-based system is not substantially the same as the hash value of the second processor-based system.

12. The system of claim 8, wherein the module to serialize the non-XML information in the first processor-based system and the module to serialize the non-XML information in second processor-based system includes a module to calculate a checksum; and further comprising a module to compare the checksum value from the first processor-based system and the checksum value from the second processor-based system.

13. The system of claim 12, wherein the module to compare the call trace with data of the first processor-based system with the call trace with data of the second processor-based system is executed only if the checksum value of the first processor-based system is not substantially the same as the checksum value of the second processor-based system.

14. The system of claim 1, wherein the first processor-based system is substantially similar to the second processor-based system.

15. A machine readable medium including instructions for executing a process comprising:
incorporating a call trace with data into one or more modules of a first processor-based system;
incorporating the call trace with data into one or more modules of a second processor-based system;
generating output from the call trace with data on the first processor-based system; and
generating output from the call trace with data on the second processor-based system;
wherein the output of the call trace with data includes XML information on one or more of program flow and data associated with execution of the first and second processor-based systems, and further comparing the output of the call trace with data of the first processor-based system with the output of the call trace with data of the second processor-based system when the output of the call trace with data comprises an XML format; and further
wherein the output of the call trace with data includes non-XML information on one or more of program flow and data associated with execution of the first and second processor-based systems, and further comprising serializing the non-XML information into an XML format and comparing the serialized data.

16. The machine readable medium of claim 15, wherein the comparing the call trace with data of the first processor-based system with the call trace with data of the second processor-based system uses an XML parser.

17. The machine readable medium of claim 15, wherein the comparing the call trace with data of the first processor-based system with the call trace with data of the second processor-based system uses an XML change detection algorithm.

18. The machine readable medium of claim 15, further comprising instructions for:
calculating a hash value for the call trace with data in the first processor-based system; and
calculating a hash value for the call trace with data in the second processor-based system;
wherein the hash values for the first processor-based system and the second processor-based system are calculated before the comparison of the call trace with data of the first processor-based system with the call trace with data of the second processor-based system; and further
wherein the comparison of the call trace with data of the first processor-based system with the call trace with data of the second processor-based system is performed only if the hash value of the first processor-based system is not substantially the same as the hash value of the second processor-based system.

19. The machine readable medium of claim 15, wherein the serializing of the non-XML information in the first processor-based system and the serializing of the non-XML information in second processor-based system includes a calculation of a checksum; and further comprising comparing the checksum value from the first processor-based system and the checksum value from the second processor-based system; and further
wherein the comparison of the call trace with data of the first processor-based system with the call trace with data of the second processor-based system is performed only if the checksum value of the first processor-based system is not substantially the same as the checksum value of the second processor-based system.

20. The machine readable medium of claim 15, wherein the first processor-based system is substantially similar to the second processor-based system.

21. A method comprising:
incorporating a call trace with data into one or more modules of a processor-based system; and
generating output from the call trace with data on the processor-based system; and
wherein the output of the call trace with data includes XML information on one or more of program flow and data associated with execution of the processor-based system;
wherein the output of the call trace with data includes non-XML information on one or more of program flow and data associated with execution of the processor-based system, and further comprising serializing the non-XML information into an XML format; and further comprising:
analyzing the XML information and the serialized data in an off-line environment.
